(19) United States
(12) Patent Application Publication
(10) Pub. No.: US 2012/0295997 A1
(43) Pub. Date: Nov. 22, 2012

(54) RESIN KNEADED MATERIAL AND SHEET

(75) Inventors: Tsuyoshi TORINARI, Osaka (JP); Hirofumi ONO, Osaka (JP); Minoru YAMANE, Osaka (JP); Eiji TOYODA, Osaka (JP); Yuusaku SHIMIZU, Osaka (JP); Tsutomu NISHIOKA, Ibaraki-shi (JP)

(73) Assignee: NITTO DENKO CORPORATION, Osaka (JP)

(21) Appl. No.: 13/475,623

(22) Filed: May 18, 2012

(30) Foreign Application Priority Data
May 20, 2011 (JP) 2011-113988
Dec. 6, 2011 (JP) 2011-266757

(51) Int. Cl. C08L 63/00; B29B 7/00

(52) U.S. Cl. 521/135; 366/96

(57) ABSTRACT

A resin kneaded material has not more than 30 pores having a pore diameter of not less than 20 μm in a surface area of 4.00 mm².

### CROSS REFERENCE TO RELATED APPLICATIONS

The present application claims priority from Japanese Patent Application No. 2011-113988 filed on May 20, 2011 and Japanese Patent Application No. 2011-266757 filed on Dec. 6, 2011, the contents of which are hereby incorporated by reference into this application.

### BACKGROUND OF THE INVENTION

1. Field of the Invention

The present invention relates to resin kneaded materials and sheets, and more particularly to a resin kneaded material used in various industrial products and a sheet formed of the resin kneaded material.

2. Description of Related Art

Conventionally, resin kneaded materials are widely used in various industrial products, specifically for sealing of electronic components. Such resin kneaded materials are prepared, for example, by kneading raw materials with a kneading machine.

As the kneading machine, for example, there has been known a continuous two-shaft kneader including a cylindrical casing provided with an input port to which materials to be processed (raw materials) are fed and an output port for ejecting them; and a kneading shaft arranged in the cylindrical casing so as to be provided with a feed screw, a paddle, and a reverse screw in order from the input port side toward the output port side.

As the resin kneaded materials, for example, there has been proposed a product (kneaded material) obtained using the above-mentioned continuous two-shaft kneader by feeding a material to be processed (e.g., thermosetting resin) from the input port into the cylindrical casing, kneading the material to be processed with the paddle provided on the kneading shaft, and then extruding the kneaded material to be processed from the output port to the outside of the cylindrical casing with the reverse screw (cf. Japanese Unexamined Patent Publication No. 11-267483).

### SUMMARY OF THE INVENTION

However, in the products (kneaded materials) described in Japanese Unexamined Patent Publication No. 11-267483, many pores (voids) having a pore diameter of not less than 100 μm may be generated. These pores in the kneaded materials may cause a problem in various industrial products using the kneaded materials.

Therefore, the present invention is to provide a resin kneaded material which can reduce pore diameters and the number of pores therein and which can be suitably used in various industrial products.

The resin kneaded material of the present invention has not more than 30 pores having a pore diameter of not less than 20 μm in a surface area of 4.00 mm².

According to the present invention, it is preferable that the resin kneaded material has a water content of 0 to 800 ppm.

The sheet of the present invention is formed of the above-mentioned resin kneaded material.

The resin kneaded material of the present invention is a resin kneaded material obtained by kneading with a kneader, the kneader comprising a barrel and a kneading shaft inserted in the barrel, one end of the barrel being provided with an introducing portion for introducing a to-be-kneaded material into the barrel; and the other end of the barrel being provided with a discharge portion for discharging a kneaded material of the to-be-kneaded material kneaded out of the barrel, the kneading shaft comprising, between the introducing portion and the discharge portion in an axial direction of the kneading shaft, a kneading section for kneading the to-be-kneaded material; and a low shear section arranged closer to the discharge portion side than the kneading section, having a smooth surface extending without unevenness along the axial direction of the kneading shaft, being introduced into the barrel from the introducing portion of the kneader and discharging from the discharge portion.

The resin kneaded material of the present invention has not more than 30 pores having a pore diameter of not less than 20 μm in a surface area of 4.00 mm². That is, the pore diameter and the number of pores (voids) in the resin kneaded material are reduced.

Accordingly, the resin kneaded material can be suitably used in various industrial products, specifically for sealing of electronic components.

### BRIEF DESCRIPTION OF THE DRAWINGS

FIG. 1 is a schematic configurational diagram illustrating an embodiment of the kneading machine used for preparation of the resin kneaded material of the present invention;

FIG. 2 is a plan sectional view of the kneading machine shown in FIG. 1 on the outlet port side;

FIG. 3 is a schematic configuration diagram illustrating another embodiment (a mode where an outlet port is formed at the other end of a barrel) of the kneading machine used for preparation of the resin kneaded material of the present invention;

FIG. 4 is a plan sectional view of the kneading machine shown in FIG. 3 on the outlet port side;

FIG. 5 is a photograph of a test piece prepared to observe a cut surface of the resin kneaded material under a microscope;

FIG. 6 is a digital microscope photograph of a section of the resin kneaded material in Example 1;

FIG. 7 is a digital microscope photograph of a section (first observed point) of the resin kneaded material in Example 2;

FIG. 8 is a digital microscope photograph of a section (second observed point) of the resin kneaded material in Example 2;

FIG. 9 is a digital microscope photograph of the section (third observed point) of the resin kneaded material in Example 2;

FIG. 10 is a digital microscope photograph of a section of the resin kneaded material in Comparative Example 1;

FIG. 11 is a digital microscope photograph of a section (first observed point) of the resin kneaded material in Comparative Example 2;

FIG. 12 is a digital microscope photograph of a section (second observed point) of the resin kneaded material in Comparative Example 2;

FIG. 13 is a digital microscope photograph of a section (third observed point) of the resin kneaded material in Comparative Example 2;

FIG. 14 is a digital microscope photograph of a section of the resin kneaded material in Example 3;

FIG. 15 is a digital microscope photograph of a section of the resin kneaded material (having a water content of 200 ppm) in Example 2;

FIG. 16 is a digital microscope photograph of a section of the resin kneaded material (having a water content of 500 ppm) in Example 2; and

FIG. 17 is a digital microscope photograph of a section of the resin kneaded material (having a water content of 800 ppm) in Example 2.

### DETAILED DESCRIPTION OF PREFERRED EMBODIMENTS

In the kneaded material of the present invention, the number of pores having a pore diameter of not less than 20 μm is 30 or less, preferably 25 or less, or more preferably 15 or less, in a surface area of 4.00 mm².

Further, in a surface area of 4.00 mm² of the resin kneaded material, the number of pores having a pore diameter of not less than 30 μm is 30 or less, or preferably 15 or less, and the number of pores having a pore diameter of not less than 10 μm is 50 or less, or preferably 25 or less.

All the pores in a surface area of 4.00 mm² of the resin kneaded material have an average pore diameter of 5 to 120 μm, or preferably 10 to 110 μm.

A total number of pores in a surface area of 4.00 mm² of the resin kneaded material is 1 to 40, or preferably 3 to 30.

The pore diameter and the number of pores per unit surface area of the resin kneaded material is determined by, for example, cutting the resin kneaded material and observing its cut surface under a microscope.

In order to determine the pore diameter and the number of pores per unit surface area of the resin kneaded material, first, the size of the resin kneaded material is adjusted.

Specifically, the resin kneaded material is adjusted to have a generally cylindrical column shape having an axial length of, for example, 5 to 40 mm or preferably 15 to 30 mm, and a diameter of, for example, 5 to 30 mm or preferably 10 to 13 mm.

Then, the resin kneaded material having the adjusted size is heated to be cured and then cooled as required.

The curing conditions include a temperature of, for example, 100 to 300° C., or preferably 150 to 200° C., and a time of, for example, 0.1 to 10 hours, or preferably 0.5 to 5 hours.

Next, the resin kneaded material thus cured is embedded in a resin for embedding to prepare a sample resin.

To prepare the sample resin, for example, the resin kneaded material is accommodated in a predetermined vessel, and the resin for embedding is poured into the vessel. The vessel is allowed to stand at a predetermined temperature to cure the resin for embedding.

The resin for embedding is a two-part mixed type resin composition including a thermosetting resin and a curing agent, and is prepared by blending a thermosetting resin and a curing agent.

Examples of the thermosetting resin include epoxy resin, polyester resin, phenol resin, and acryl resin.

Examples of the curing agent include an organic phosphorous compound, an acid anhydride, and an amine compound.

The amount of the curing agent blended with 100 parts by mass of the thermosetting resin is, for example, from 1 to 30 parts by mass, or preferably from 5 to 20 parts by mass.

The curing conditions of the resin for embedding include a temperature of, for example, 10 to 40° C., or preferably 20 to 30° C., and a standing time of, for example, 1 to 20 hours, or preferably 5 to 10 hours.

Thus, a sample resin having the resin kneaded material embedded therein is prepared.

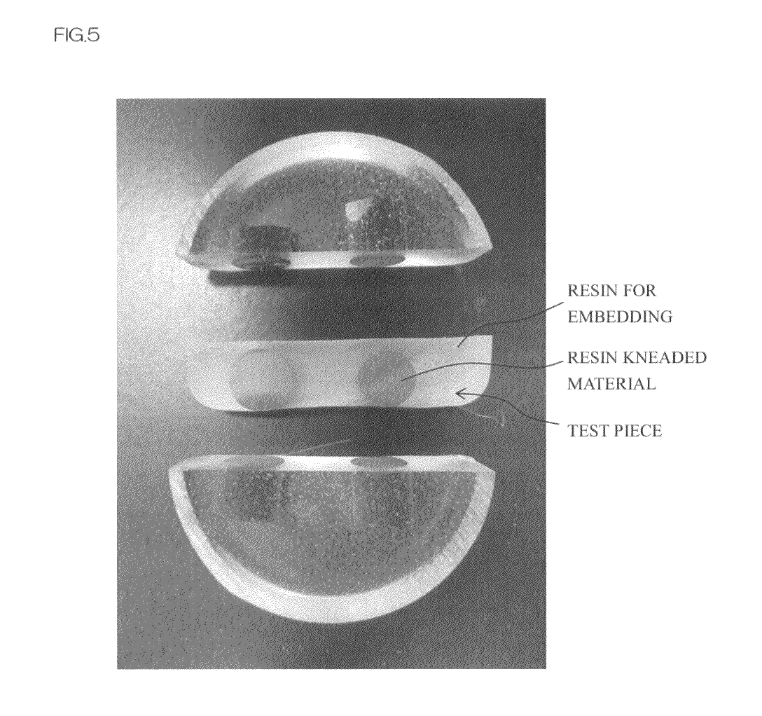

Next, the sample resin is cut, for example, with a precision cutting machine so that the resin kneaded material is positioned in the center portion of the cut surface, to thereby prepare a test piece having a thickness of, for example, 1 to 10 mm (see FIG. 5).

Subsequently, the cut surface of the test piece is polished with a polisher.

Specifically, the cut surface thereof is polished under three-step polishing conditions.

Initial polishing conditions (first-step polishing) include polishing paper of, for example, 240 grit, a rotation speed of a polishing paper table of, for example, 10 to 100 rpm ( 1/60 s⁻¹), a pressurizing force to the test piece of, for example, 5 to 8, and a polishing time of, for example, 3 to 5 minutes.

Second-step polishing conditions include polishing paper of, for example, 600 grit, a rotation speed of the polishing paper table of, for example, 10 to 100 rpm ( 1/60 s⁻¹), a pressurizing force to the test piece of, for example, 8 to 10, and a polishing time of, for example, 3 to 5 minutes.

Third-step polishing conditions include polishing paper of, for example, 800 grit, a rotation speed of the polishing paper table of, for example, 10 to 100 rpm ( 1/60 s⁻¹), a pressurizing force to the test piece of, for example, 10 to 15, and a polishing time of, for example, 5 to 10 minutes.

For the three-step polishing, polishing powder may be used instead of polishing paper.

Next, the cut surface thus polished is observed under a microscope such as a digital microscope.

As described above, the pore diameter and the number of pores per unit surface area of the resin kneaded material are determined by microscopic observation.

The resin kneaded material has a water content of, for example, 0 to 800 ppm, preferably 500 ppm or less, or more preferably 400 ppm or less. The water content of the resin kneaded material can be measured by a Karl Fischer titration method (specifically, a Karl-Fischer water content measuring apparatus).

The water content of the resin kneaded material adjusted within the above range can reduce the average pore diameter of all the pores per unit surface area of the resin kneaded material.

The water content of the resin kneaded material can be adjusted within the above range by drying the resin kneaded material or a material to be kneaded (described later) serving as a raw material by a known method (e.g., a dryer) as required.

The resin kneaded material has a resin density of, for example, 98 to 100% or preferably 98 to 100%. The resin density is a percentage of the value obtained by subtracting the ratio of a total cross section of all pores (sum total of the cross sections of all pores) in a surface area of 4.00 mm² of the resin kneaded material to the surface area of 4.00 mm² thereof from 1.

The resin kneaded material has a viscosity at a temperature of 90 to 120° C. of, for example, 50 to 5000 Pa·s, preferably 50 to 3000 Pa·s, or more preferably 50 to 1000 Pa·s. The viscosity can be measured with an ARES viscometer (manufactured by Rheometric Scientific).

Such resin kneaded material is prepared, for example, by kneading the material to be kneaded serving as a raw material with a kneader.

Examples of the material to be kneaded include a resin or a mixture of a resin and an additive.

Examples of the resin include thermosetting resins such as epoxy resin, phenol resin, amino resin, diallyl phthalate resin, and alkyd resin; and thermoplastic resins such as polyamide resin, polycarbonate resin, polyethylene resin, and polypropylene resin.

Of these resins, a thermosetting resin is preferable.

These resins may be used alone or in combination.

Examples of the additive include curing agents such as an amine compound, an acid anhydride compound, and a phenol resin; curing accelerators such as an imidazole compound; fillers such as silica, alumina, and metal hydroxide; flexibilizers such as an acrylic copolymer, a polystyrene-polyisobutylene copolymer, and a styrene acrylate copolymer; and coloring agents such as carbon black.

Of these curing agents, a phenol resin is preferable.

These curing agents may be used alone or in combination.

Of these fillers, a silica subjected to surface treatment with a silane coupling agent is preferable.

These fillers may be used alone or in combination.

Of these flexibilizers, a polystyrene-polyisobutylene copolymer is preferable.

These flexibilizers may be used alone or in combination.

Such additive is appropriately varied depending on the kind of the above-mentioned resin.

When the material to be kneaded is a mixture of a resin and an additive, a total mixing amount of the additive is, for example, from 80 to 99 parts by mass, or preferably from 85 to 98 parts by mass, per 100 parts by mass of the mixture.

Specifically, the curing agent is mixed in an amount of, for example, 1 to 20 parts by mass, or preferably 2 to 10 parts by mass, per 100 parts by mass of the mixture.

The curing accelerator is mixed in an amount of, for example, 0.05 to 5 parts by mass, or preferably 0.1 to 1 parts by mass, per 100 parts by mass of the mixture.

The filler is mixed in an amount of, for example, 60 to 95 parts by mass, or preferably 75 to 90 parts by mass, per 100 parts by mass of the mixture.

When the filler is subjected to surface treatment with a silane coupling agent, the silane coupling agent is used in an amount of, for example, 0.1 to 1.0 part by mass, or preferably 0.1 to 0.5 parts by mass, per 100 parts by mass of the filler.

The flexibilizer is mixed in an amount of, for example, 3 to 30 parts by mass, or preferably 3 to 20 parts by mass, per 100 parts by mass of the mixture.

The coloring agent is mixed in an amount of, for example, 0.01 to 1 part by mass, or preferably 0.05 to 0.5 parts by mass, per 100 parts by mass of the mixture.

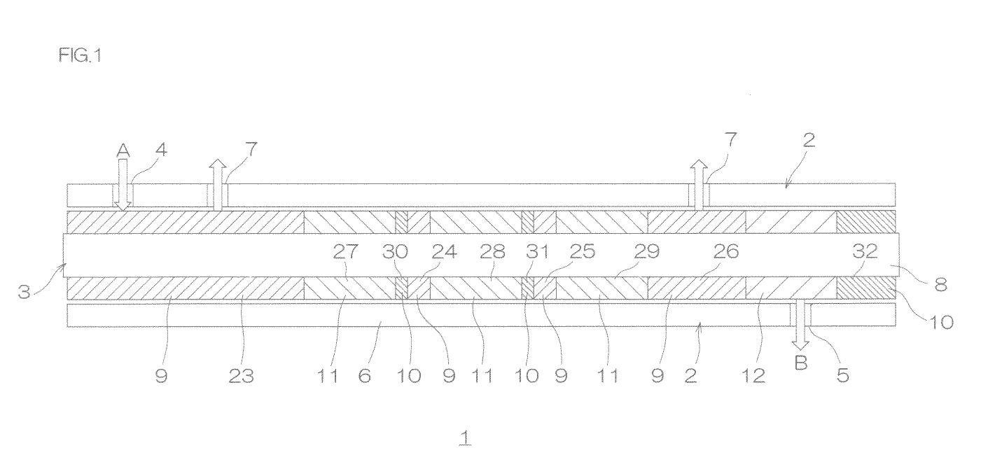

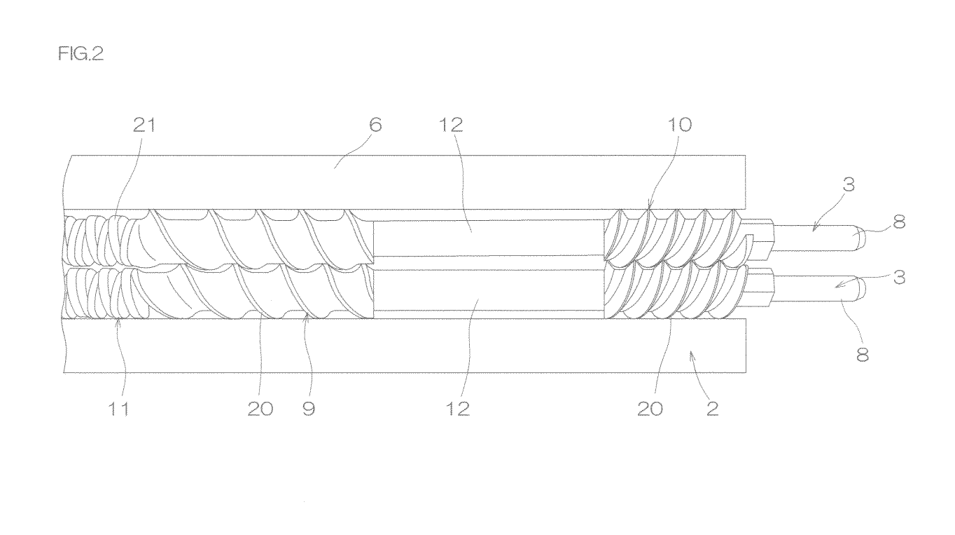

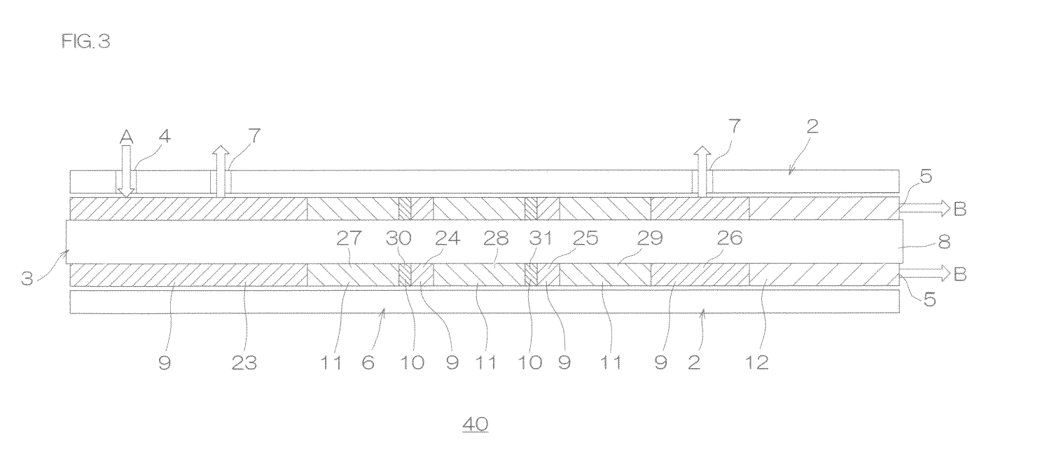

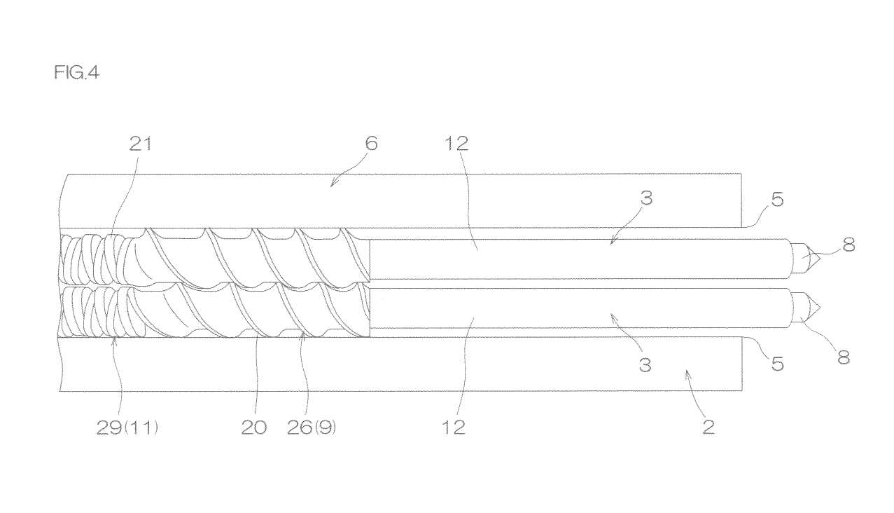

Examples of the kneader include a kneader 1 shown in FIGS. 1 and 2 and a kneader 40 shown in FIGS. 3 and 4.

FIG. 1 is a schematic configurational diagram illustrating an embodiment of the kneading machine used for preparation of the resin kneaded material of the present invention, and FIG. 2 is a plan sectional view of the kneading machine shown in FIG. 1 on the outlet port side.

As shown in FIG. 2, the kneader 1 is a continuous two-shaft kneader, including a barrel 2 and two kneading shafts 3.

The barrel 2 is formed in a generally elliptical tubular shape as shown in FIG. 1, one end of which is provided with an inlet port 4 as an example of an introducing portion for introducing a material to be kneaded (hereinafter referred to as to-be-kneaded material A) into the barrel 2; and the other end of which is provided with an outlet port 5 as an example of a discharge portion for discharging the resin kneaded material of the to-be-kneaded material A kneaded out of the barrel 2.

The inlet port 4 is formed on one end side of the barrel 2 so as to penetrate the side wall of the barrel 2 on one radially outer side of the kneading shaft 3 (described later).

The outlet port 5 is formed on the other end side of the barrel 2 so as to penetrate the side wall of the barrel 2 on the other radially outer side of the kneading shaft 3 (described later).

The sectional shape of the outlet port 5 may be, for example, a rectangular shape, an elliptical shape, or a circular shape. Of these, an elliptical shape and a circular shape are preferable.

The cross section of the outlet port 5 is, for example, 7 to 50%, or preferably 7 to 20% of the cross section of the barrel 2.

A melt-kneading portion 6 in which the to-be-kneaded material A is melt-kneaded is formed between the inlet port 4 and the outlet port 5 in the barrel 2.

The melt-kneading portion 6 includes a plurality (two) of vents 7 at locations in the axial direction so as to eject gas contained in the melt-kneading portion 6.

Each of the vents 7 is formed on one radially outer side of the kneading shaft 3 (described later) so as to penetrate the side wall of the barrel 2. That is, the vents 7 and the inlet port 4 are formed in parallel to one another in the radial direction of the kneading shaft 3 (described later).

The vents 7 are normally closed and can be appropriately opened as required.

More specifically, the plurality of vents 7 include an inlet port side vent 7 provided near the other end of the inlet port 4 and an outlet port side vent 7 provided near one end of the outlet port 5 in a direction which goes from one end side of the barrel 2 to the other end side thereof.

The vent 7 near the outlet port 5 is coupled with a pump (not shown), and a suction force generated by driving the pump (not shown) causes gas in the melt-kneading portion 6 to be sucked.

A heater (not shown) is provided in the melt-kneading portion 6, so that the temperature in the melt-kneading portion 6 is appropriately controlled at each of block units in the direction which goes from one end side of the barrel 2 to the other end side thereof.

The kneading shafts 3 are rotating shafts arranged in the barrel 2 to mix and shear the to-be-kneaded material A, in which a drive shaft 8, a feed screw 9, a reverse screw 10, a paddle 11 as an example of a kneading section, a pipe 12 as an example of a low shear section are integrally formed.

Specifically, each of the kneading shafts 3 includes one drive shaft 8, a plurality (four) of feed screws 9, a plurality (three) of reverse screws 10, a plurality (three) of paddles 11, and one pipe 12.

The axial length of and the number of feed screws 9, the reverse screws 10, the paddles 11, and the pipe 12 can be appropriately varied as required.

The plurality (four) of feed screws 9 are sections for transporting the to-be-kneaded material A toward the outlet port 5. Specifically, they are formed with a first feed portion 23, a second feed portion 24, a third feed portion 25, and a fourth feed portion 26, and these portions are spaced apart from one another in the axial direction of the drive shaft 8.

The first feed portion 23 is arranged at one end of the kneading shaft 3. When the inlet port 4 and the vent 7 near the inlet port 4 are projected in the radial direction of the drive shaft 8, the first feed portion 23 is overlapped with their projection planes. Further, the first feed portion 23 is formed so as to have the longest length in the axial direction of the drive shaft 8 as compared with the other feed portions.

The fourth feed portion 26 is the closest to the outlet port 5 among the four feed portions. When the vent 7 near the outlet port 5 is projected in the radial direction of the drive shaft 8, the fourth feed portion 26 is overlapped with the projection plane of the vent 7. Further, the fourth feed portion 26 is formed with an approximately half length of the first feed portion 23 in the axial direction of the drive shaft 8.

The second feed portion 24 and the third feed portion 25 are arranged between the first feed portion 23 and the fourth feed portion 26, and are formed with a length that is approximately one-tenth the length of the first feed portion 23 in the axial direction of the drive shaft 8.

As shown in FIG. 2, each of the feed screws 9 has a spiral screw thread 20 protruded from the outer peripheral surface of the drive shaft 8.

Specifically, the screw thread 20 of the feed screw 9 is formed in a spiral form in the same direction as the rotation direction (described later) of the drive shaft 8. That is, each of the feed screws 9 has a right-handed screw thread 20.

The screw thread 20 in the feed screw 9 has a pitch length of, for example, 0.6 to 2.0 cm, or preferably 1.5 to 2.0 cm.

The plurality (three) of reverse screws 10 are formed with a first reverse portion 30, a second reverse portion 31, and a third reverse portion 32 as shown in FIG. 1, and these portions are spaced apart from one another in the axial direction of the kneading shaft 3.

The third reverse portion 32 is arranged at the other end of the kneading shaft 3 and is formed so as to have the longest length in the axial direction of the drive shaft 8 as compared with the other reverse portions. The length thereof in the axial direction of the drive shaft 8 is approximately one-quarter of the length of the first feed portion 23.

The first reverse portion 30 is arranged between the first feed portion 23 and the second feed portion 24 so as to be adjacent to the second feed portion 24.

The second reverse portion 31 is arranged between the second feed portion 24 and the third feed portion 25 so as to be adjacent to the third feed portion 25.

The first reverse portion 30 and the second reverse portion 31 each have a length approximately one-fifth the length of the third reverse portion 32 in the axial direction of the drive shaft 8.

As well as the feed screws 9, each of the reverse screws 10 has the spiral screw thread 20 protruded from the outer peripheral surface of the drive shaft 8 as shown in FIG. 2.

The screw thread 20 of the reverse screw 10 is, however, formed in a spiral form in a direction opposite to the screw thread 20 of the feed screw 9. That is, each of the reverse screws 10 has a left-handed screw thread 20.

The screw thread 20 of the reverse screw 10 has a pitch length of, for example, 0.6 to 1.5 cm, or preferably 1.0 to 1.5 cm.

The plurality (three) of paddles 11 are sections for kneading the to-be-kneaded material A. Specifically, they are formed with a first paddle 27, a second paddle 28, and a third paddle 29, and these paddles are spaced apart from one another in the axial direction of the kneading shaft 3.

The first paddle 27 is arranged between the first feed portion 23 and the first reverse portion 30.

The second paddle 28 is arranged between the second feed portion 24 and the second reverse portion 31.

The third paddle 29 is arranged between the third feed portion 25 and the fourth feed portion 26.

The first paddle 27, the second paddle 28, and the third paddle 29 have approximately the same length in the axial direction of the drive shaft 8, which is a length approximately one-third the length of the first feed portion 23.

As shown in FIG. 2, each of the paddles 11 has a plurality of paddle blades 21 of generally elliptical plate-like shape provided in parallel along the axial direction of the drive shaft 8.

More specifically, the plurality of paddle blades 21 are arranged in parallel in the axial direction of the drive shaft 8 so that the major axes of the paddle blades 21 adjacent to one another are displaced by an angle of approximately 90°.

The pipe 12 is formed in a generally cylindrical shape along the axial direction of the drive shaft 8 without unevenness on its entire perimeter.

The pipe 12 is arranged between the fourth feed portion 26 and the third reverse portion 32. When the outlet port 5 is projected in the radial direction of the drive shaft 8, the pipe 12 is overlapped with the projection plane of the outlet port 5. The pipe 12 is formed with an approximately half length of the first feed portion 23 in the axial direction of the drive shaft 8.

That is, on each of the kneading shafts 3, as shown in FIG. 1, the first feed portion 23, the first paddle 27, the first reverse portion 30, the second feed portion 24, the second paddle 28, the second reverse portion 31, the third feed portion 25, the third paddle 29, the fourth feed portion 26, the pipe 12, and the third reverse portion 32 are arranged in order from one end side of the drive shaft 8 toward the other end side thereof.

In short, on each of the kneading shafts 3, a unit including a feed portion, a paddle, and a reverse portion is repeatedly arranged from one end side of the drive shaft 8 toward the other end side thereof. Further, in the other end side unit, a feed portion and a pipe are arranged between a paddle and a reverse portion.

As shown in FIG. 2, the two kneading shafts 3 are arranged in the barrel 2 along the axial direction and arrange in parallel along the radial direction.

The two kneading shafts 3 are arranged so as not to interfere with their rotation drives in the portions (the feed screws 9, the reverse screws 10, and the paddles 11).

Both ends of the drive shafts 8 in the kneading shafts 3 are protruded outward in the axial direction of the barrel 2. Of these protruded ends, one end is relatively unrotatably coupled with a driving source (not shown) while the other end is relatively rotatably supported on a supporting wall (not shown). In short, the kneading shafts 3 are rotationally driven around the axes of the drive shafts 8 by transferring a driving force from the driving source (not shown) to the drive shafts 8. Specifically, the kneading shafts 3 rotate clockwise in the axial direction of the drive shaft 8 when viewed from the inlet port 4 side to the outlet port 5 side.

As shown in FIG. 1, the inner peripheral surface of the barrel 2 is slightly spaced in opposed relation to the feed screws 9, the reverse screws 10, and the paddles 11 of the kneading shafts 3 in the radial direction of the kneading shaft 3. In contrast, the inner peripheral surface of the barrel 2 is widely spaced apart from the pipe 12 in the radial direction of the kneading shaft 3 as compared with the other portions.

To prepare a resin kneaded material with the kneader 1, first, the to-be-kneaded material A is introduced into the barrel 2 from the inlet port 4 of the kneader 1.

Then, when the driving force from the driving source (not shown) is transferred to the drive shaft 8, the kneading shafts 3 rotationally drive, so that the to-be-kneaded material A is transported toward the first paddle 27 while stirred with the first feed portion 23.

At this time, the temperature of the barrel 2 (melt-kneading portion 6) positioned outward from the first feed portion 23 is adjusted to, for example, 20 to 25° C. with a heater (not shown). Along with the introduction of the to-be-kneaded material A, air which enters into the barrel 2 is emitted outside of the barrel 2 by opening the vent 7 near the inlet port 4.

Then, the to-be-kneaded material A thus transported is kneaded in the first paddle 27.

At this time, the temperature of the melt-kneading portion 6 positioned outward from the first paddle 27 is adjusted to, for example, 40 to 80° C. with a heater (not shown).

The to-be-kneaded material A thus kneaded is then extruded toward the first reverse portion 30 by an extruding force of the to-be-kneaded material A transported by the rotation drive of the first feed portion 23.

Most of the to-be-kneaded material A thus extruded passes through the first reverse portion 30 and reaches the second feed portion 24. On the other hand, some of the to-be-kneaded material A thus extruded are returned to the first paddle 27 by the rotation drive of the first reverse portion 30 and then kneaded again.

As a result of this, the kneading of the to-be-kneaded material A is accelerated and the transporting rate of the to-be-kneaded material A is adjusted.

Subsequently, the to-be-kneaded material A thus passed through the first reverse portion 30 is transported by the second feed portion 24 toward the second paddle 28 and the second reverse portion 31.

Thus, the to-be-kneaded material A passes through the second paddle 28 and the second reverse portion 31 while kneaded, in the same manner as the first paddle 27 and the first reverse portion 30.

At this time, the temperature of the melt-kneading portion 6 positioned outward from the second paddle 28 is adjusted to, for example, 60 to 120° C. with a heater (not shown).

Then, the to-be-kneaded material A thus passed through the second reverse portion 31 is transported to the third paddle 29 by the subsequent third feed portion 25 and further kneaded in the third paddle 29. This allows the to-be-kneaded material A to prepare a resin kneaded material (hereinafter referred to as a resin kneaded material B).

At this time, the temperature of the melt-kneading portion 6 positioned outward from the third paddle 29 is adjusted to, for example, 80 to 140° C. with a heater (not shown).

The resin kneaded material B is then extruded by the rotation drive of the kneading shafts 3 to reach the fourth feed portion 26.

At this time, water or volatile components in the resin kneaded material B is/are ejected out of the melt-kneading portion 6 by driving a pump (not shown) coupled with the vent 7 near the outlet port 5.

Thus, the number of pores in the resin kneaded material B can be reduced.

Subsequently, the resin kneaded material B is transported to the pipe 12 by the fourth feed portion 26.

As described above, the pipe 12 is formed without having unevenness on its entire perimeter. Therefore, in the pipe 12, the shear in a direction intersecting the axial direction of the kneading shaft 3 is suppressed, so that the resin kneaded material B is smoothly moved along the axial direction of the pipe 12.

Then, most of the resin kneaded material B is discharged from the outlet port 5.

On the other hand, the resin kneaded material B which passes through the outlet port 5 without being discharged to thereby reaching the third reverse portion 32 is also put back by the third reverse portion 32, so that the resin kneaded material B is discharged from the outlet port 5.

Accordingly, the resin kneaded material B is prepared.

After kneaded with the paddles 11, the resin kneaded material B passes through the pipe 12 in which the shear in the direction intersecting the axial direction of the kneading shaft 3 is suppressed and then discharged from the outlet port 5. Therefore, the generation of pores, that is, the pore diameter and the number of pores can be reduced.

FIG. 3 is a schematic configuration diagram illustrating another embodiment (a mode where an outlet port is formed at the other end of a barrel) of the kneading machine used for preparation of the resin kneaded material of the present invention, and FIG. 4 is a plan sectional view of the kneading machine shown in FIG. 3 on the outlet port side.

The kneader 40 has the same configuration as the kneader 1 except that the other end of the barrel 2 is formed as the outlet port 5.

Therefore, in FIGS. 3 and 4, the same reference numerals are provided for members corresponding to each of those described in FIGS. 1 and 2 and their description is omitted.

In the kneader 40, the other end of the barrel 2 is formed as the outlet port 5. Therefore, it is not necessary to provide the third reverse portion 32 for putting back the kneaded material B to the outlet port 5, the kneaded material B passing through the outlet port 5 without being discharged, and the pipe 12 is extended so that its distal end may protrude from the outlet port 5 (the other end of the barrel 2).

When the resin kneaded material is prepared with the kneader 40, the resin kneaded material B is discharged from the outlet port 5 without putting back by the third reverse portion 32 because the third reverse portion 32 is not provided in the kneader 40.

Therefore, mixing of the gas in the resin kneaded material B is prevented, which can suppress the generation of pores in the resin kneaded material B.

In the kneader 40, since the other end of the barrel 2 is formed as the outlet port 5, the other end of the drive shaft 8 is not supported and only one end of the drive shaft 8 is supported by relatively unrotatably coupling with the drive source (not shown). This allows the kneading shafts 3 to be relatively rotatably supported to the barrel 2.

The sectional shape of the outlet port 5 in the kneader 40 may be, for example, a rectangular shape, an elliptical shape, or a circular shape. Of these, an elliptical shape and a circular shape are preferable.

The cross section of the outlet port 5 in the kneader 40 is, for example, 15 to 50%, or preferably 20 to 45% of the cross section of the barrel 2.

Although a known die may be attached to the outlet port 5 of the kneader 40 as required, the above-mentioned resin kneaded material B is defined as a resin kneaded material at the time of being discharged from the outlet port 5.

The resin kneaded material B prepared as described above is shaped into a sheet by a molding method such as a mixing roll, a calendar roll, extrusion molding, or press molding.

Of these molding methods, extrusion molding is preferable.

The sheet thus shaped is particularly a resin sheet having a thickness of, for example, 100 to 1500 μm, or preferably 300 to 1000 μm. Such sheet can also be formed as a monolayer of the resin kneaded material B only or a plurality of layers laminated on a base material such as a glass fiber cloth.

The resin kneaded material of the present invention has not more than 30 pores having a pore diameter of not less than 20 μm in a surface area of 4.00 mm².

Therefore, the resin kneaded material of the present invention can be suitably used in various industrial products, specifically for sealing (encapsulating) of electronic components such as a semiconductor device, a condenser, and a resistive element on a mounting board.

Further, since the sheet of the present invention is formed of the above-mentioned resin kneaded material, it can be suitably used for sealing (encapsulating) of electronic components described above, and the handleability thereof can be improved because of its sheet-like shape.

### EXAMPLES

While in the following, the present invention will be described in further detail with reference to Examples and Comparative Examples, the present invention is not limited to any of them.

### Examples 1 and 2

In the formulation (unit: mass part) shown in TABLE 1, each of the components (to-be-kneaded materials) was introduced from the inlet port 4 of the kneader 1 shown in FIG. 1, to thereby obtain a resin kneaded material. It should be noted that the resin kneaded material prepared according to Formulation Example 1 was determined as Example 1, and the resin kneaded material prepared according to Formulation Example 2 was determined as Example 2.

The resin kneaded material in Example 2 had a resin density of 98.9% and a water content of 188 ppm.

### Example 3

In the formulation (unit: mass part) shown in TABLE 2, each of the components (to-be-kneaded materials) was introduced from the inlet port 4 of the kneader 40 shown in FIG. 3, to thereby obtain a resin kneaded material (Example 3).

The resin kneaded material in Example 3 had a resin density of 99.7% and a water content of 232 ppm.

### Comparative Examples 1 and 2

A kneader in which the pipe 12 of the kneader 1 shown in FIG. 1 was replaced with the feed screw 9 was prepared.

Each of the components (to-be-kneaded materials) in the formulation shown in TABLE 1 was introduced from the inlet port 4 of the kneader, to thereby obtain a resin kneaded material. It should be noted that the resin kneaded material prepared according to Formulation Example 1 was determined as Comparative Example 1, and the resin kneaded material prepared according to Formulation Example 2 was determined as Comparative Example 2.

The resin kneaded material in Comparative Example 2 had a resin density of 95.8% and a water content of 180 ppm.

TABLE 1

| Formulation Example | | Ex. 1 | Ex. 2 |
|---|---|---|---|
| To-be-kneaded | Epoxy Resin (YSLV-80XY) | 229.03 | 399.06 |
| Materials | Phenol Resin (MEH7851SS) | 242.21 | 422.04 |
| | Curing Accelerator (2PHZ-PW) | 4.76 | 11.9 |
| | Flexibilizer (SIBSTAR) | — | 357 |
| | Filler | 3520 | 8800 |
| | Carbon Black (#20) | 4 | 10 |
| | TOTAL | 4000 | 10000 |

The abbreviations in TABLE 1 are shown below.

YSLV-80XY: Epoxy resin (manufactured by Nippon Steel Chemical Co., Ltd.)

MEH7851SS: Phenol resin (manufactured by Meiwa Plastic Industries, Ltd.)

2PHZ-PW: Imidazole (manufactured by Shikoku Chemicals Corporation)

SIBSTAR: Elastomer (polystyrene-polyisobutylene copolymer) (manufactured by Kaneka Corporation)

Filler: Surface-treated filler obtained by adding 0.1 parts by mass of a silane coupling agent (KBM403, manufactured by Shin-Etsu Chemical Co., Ltd.) to 100 parts by mass of an inorganic filler (fused silica) (FB-9454, manufactured by DENKI KAGAKU KOGYO K.K.).

#20: Carbon black (manufactured by Mitsubishi Chemical Corporation)

Evaluation

### (1) Determination of Number of Pores

The number of pores in each of the resin kneaded materials obtained in Examples and Comparative Examples was determined as follows. The results are shown in TABLE 2.

The resin kneaded material obtained in each of Examples and Comparative Examples was adjusted so as to have a generally cylindrical column shape having an axial length of 15 to 30 mm and a diameter of 10 to 13 mm.

Each of the resin kneaded materials thus adjusted in size was fed into a dryer set to a temperature of 175° C. for 1 hour to be cured. Subsequently, the resin kneaded materials were taken out from the dryer and then cooled in a predetermined vessel.

On the other hand, a resin for embedding which embedded the resin kneaded materials was prepared. Specifically, an EPOFIX cold-setting resin (two-part mixed type resin including an epoxy resin and a curing agent) including 3 parts by mass of a curing agent blended with 25 parts by mass of an epoxy resin was used to prepare a resin for embedding in a required volume.

Then, the resin for embedding was flowed into the vessel where the resin kneaded materials were accommodated so that the resin kneaded materials were fully immersed therein. The vessel was then allowed to stand until the resin for embedding was completely cured (at a room temperature, approximately 25° C., for 7 to 8 hours). Thus, a sample resin having the resin kneaded materials embedded therein was produced.

Subsequently, the sample resin was taken out from the vessel and then cut using a precision cutting machine (Isomet 1000 manufactured by Buehler) so that each of the resin kneaded materials was positioned in the center portion of the cut surface. As a result, test pieces (approximately 5 mm to 7 mm in thickness) were obtained (see FIG. 5).

According to the following apparatus and conditions, the cut surfaces of the obtained test pieces were polished.

Polishing Apparatus and Polishing Conditions

Polisher: AutoMet 3000 manufactured by Buehler

### 1) Initial Polishing Conditions

Polishing paper of grit size: #240, rotation speed of polishing paper table: 50 rpm ( 1/60 s⁻¹), pressurizing force to test piece: 5 to 8, and polishing time: 3 to 5 min.

### 2) Second Step Polishing Conditions

Polishing paper of grit size: #600, rotation speed of polishing paper table: 50 rpm ( 1/60 s⁻¹), pressurizing force to test piece: 8 to 10, and polishing time: 3 to 5 min.

### 3) Third Step Polishing Conditions

A polishing powder (MICROPOLISH 0.3) mixed with an appropriate amount of water was used instead of the polishing paper.

Rotation speed of polishing table: 60 rpm ( 1/60 s⁻¹), pressurizing force to test piece: 10 to 15, and polishing time: 5 to 10 min.

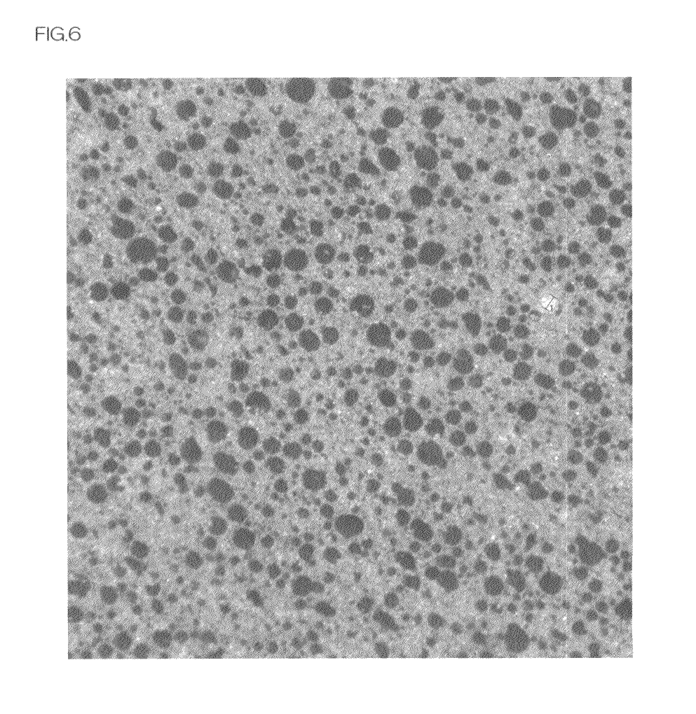

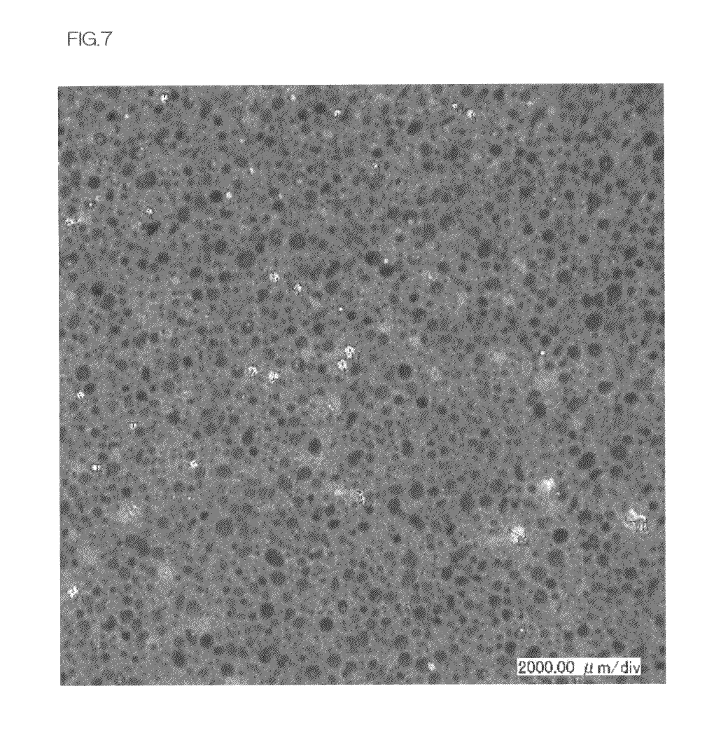

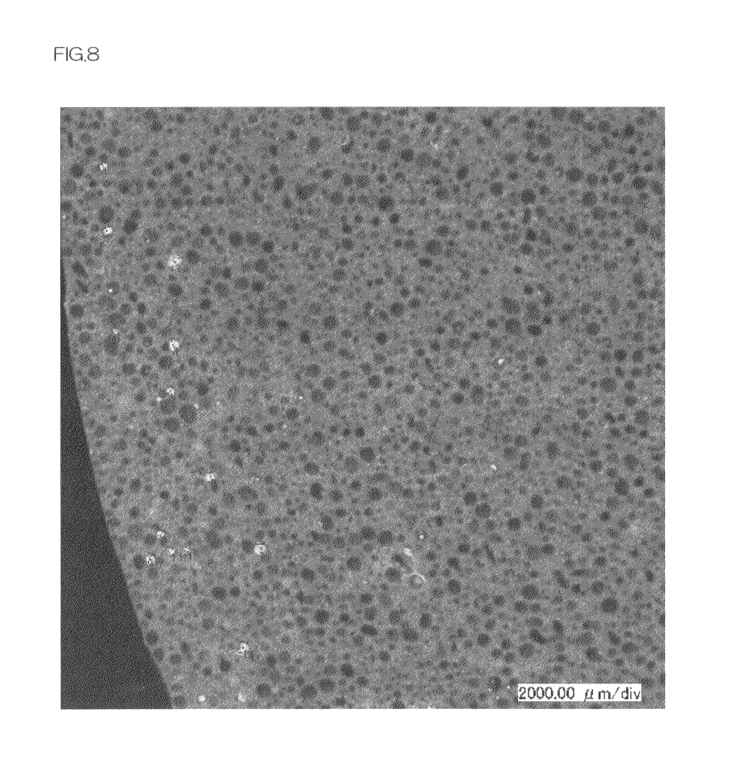

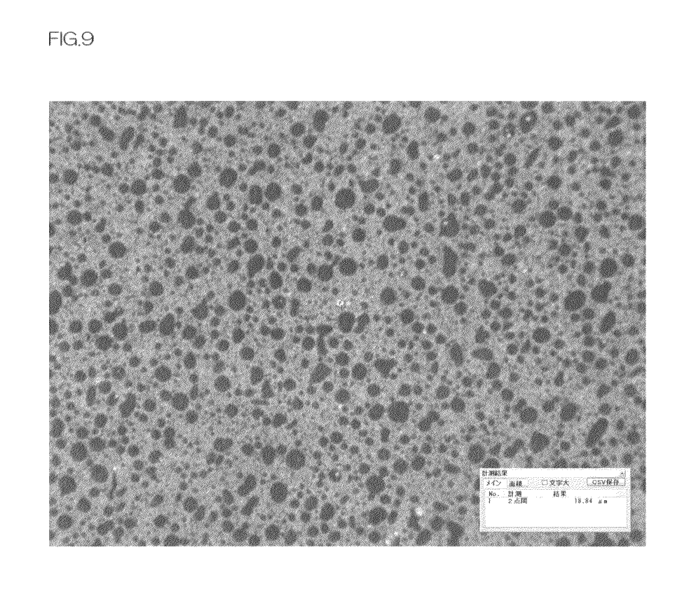

In a 2 mm×2 mm area of the kneaded material in each of the polished test pieces, the number of pores and the pore diameter were observed under a digital microscope (manufactured by KEYENCE: VHX-500, observation magnification: 100 times). FIG. 6 is a digital microscope photograph of a section of the resin kneaded material in Example 1. FIGS. 7 to 9 are digital microscope photographs of sections (first to third observed points) of the resin kneaded material in Example 2.

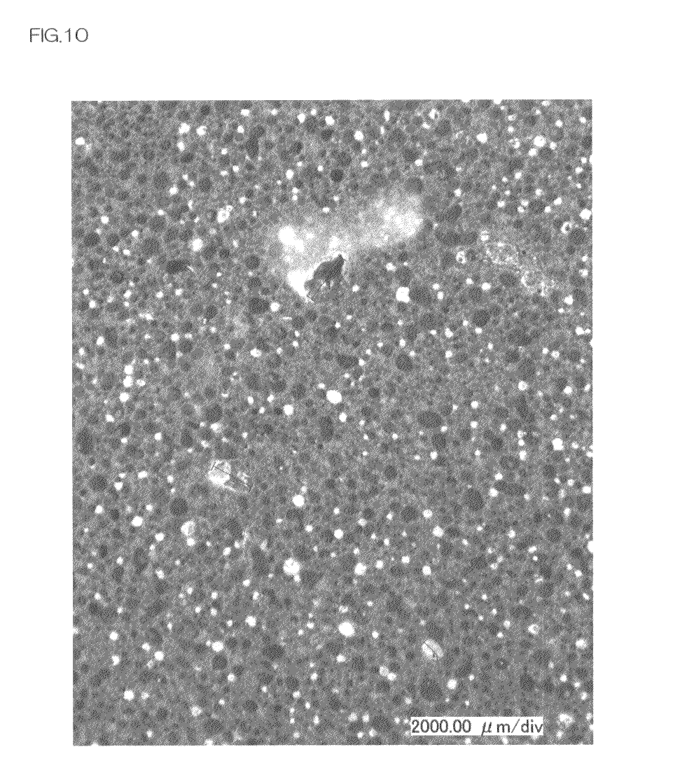

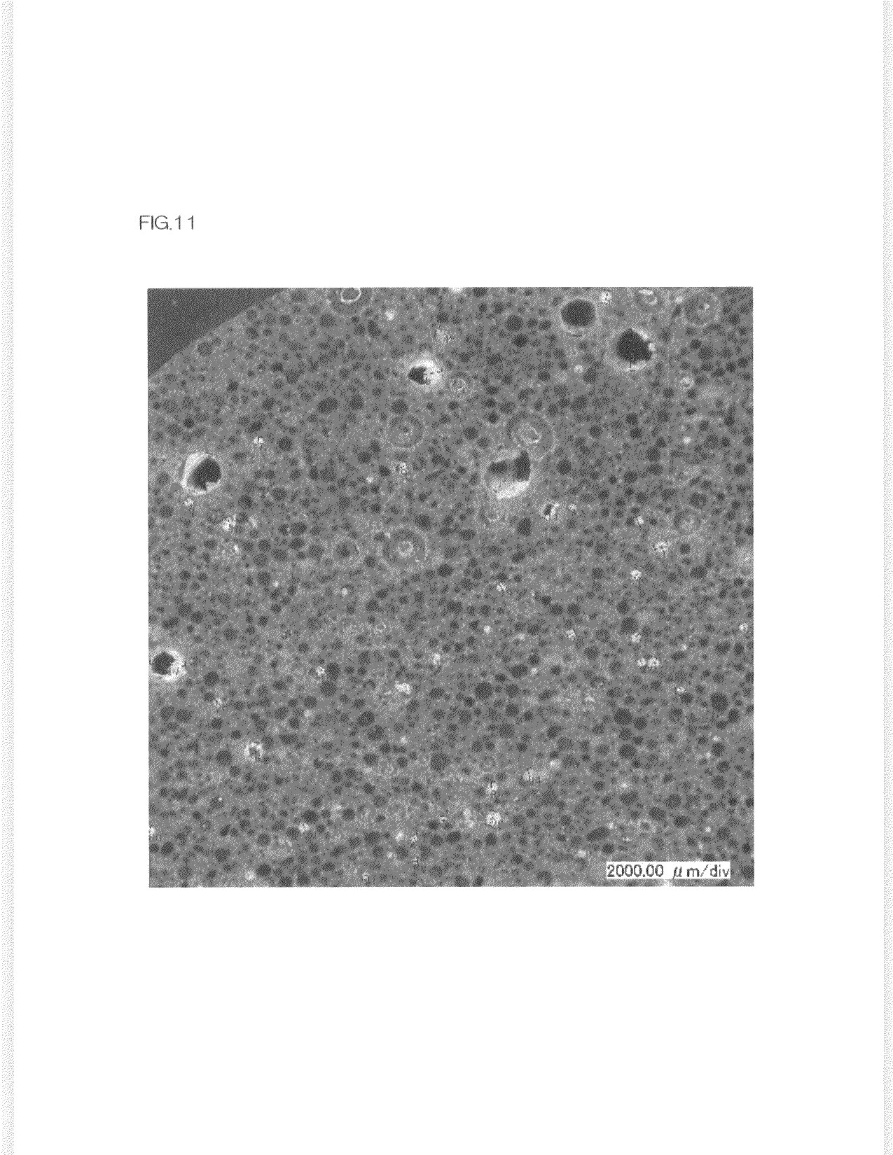

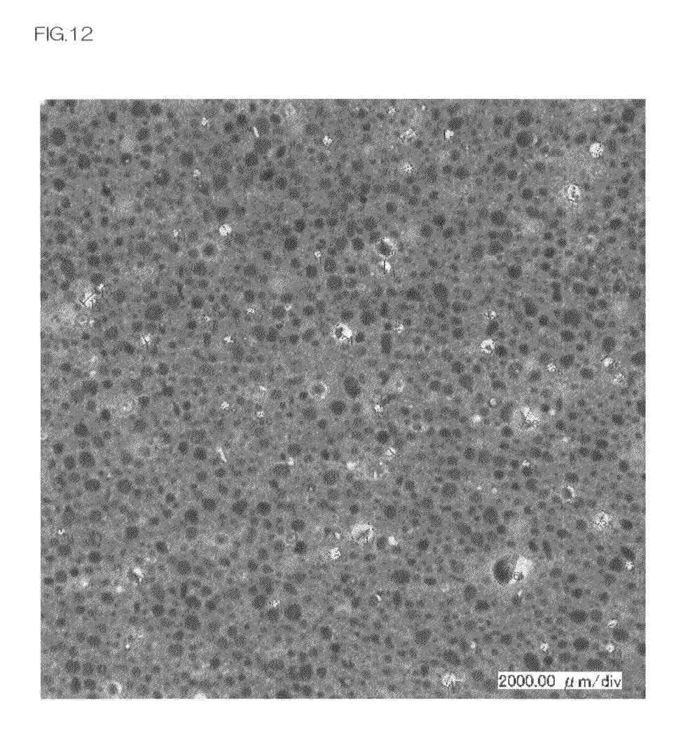

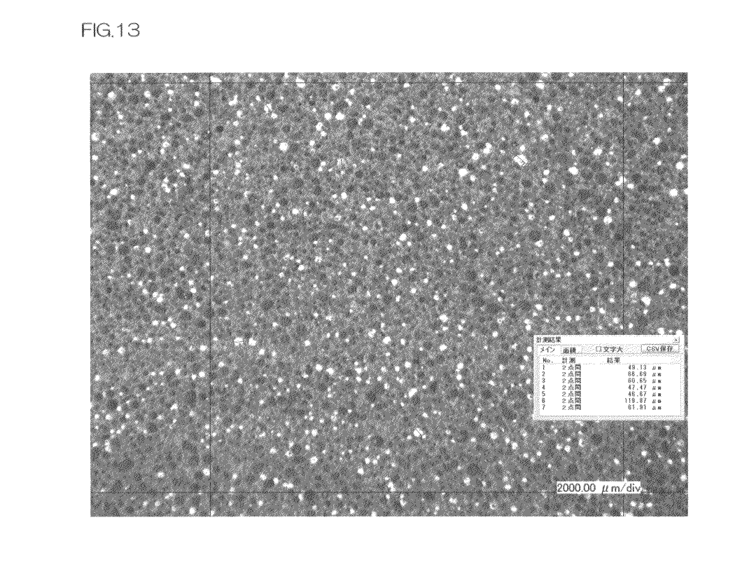

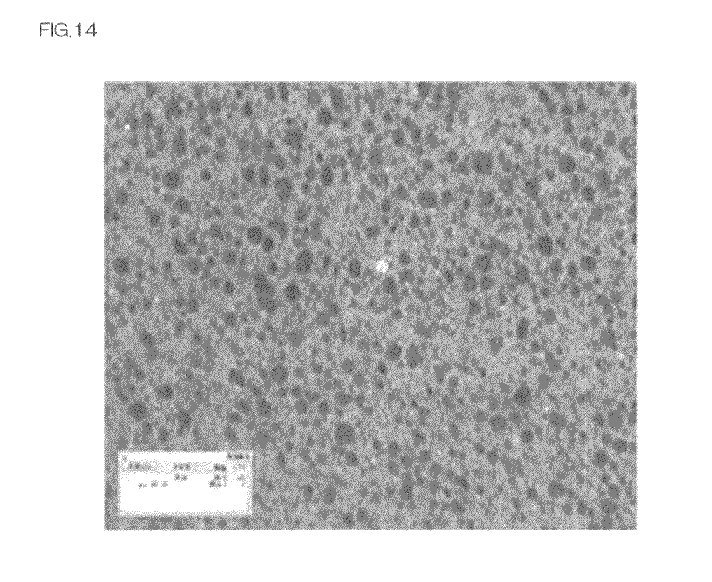

Further, FIG. 10 is a digital microscope photograph of a section of the resin kneaded material in Comparative Example 1. FIGS. 11 to 13 are digital microscope photographs of sections (first to third observed points) of the resin kneaded material in Comparative Example 2. FIG. 14 is a digital microscope photograph of a section of the resin kneaded material in Example 3.

In Example 1 and Comparative Example 1, five points in the 2 mm×2 mm area were observed.

In Example 2, four points in the 2 mm×2 mm area were observed.

In Comparative Example 2, three points in the 2 mm×2 mm area were observed.

In Example 3, one point in the 2 mm×2 mm area was observed.

TABLE 2

| | | Evaluation Points | | | | |
|---|---|---|---|---|---|---|
| | | 1 | 2 | 3 | 4 | 5 |
| Ex. 1 | No. of Pores | 22 | 19 | 14 | 25 | 20 |
| | Avg. Pore | 68 | 49 | 45 | 51 | 100 |
| | Dia. (μm) | | | | | |
| Comp. | No. of Pores | 44 | 32 | 46 | 47 | 54 |
| Ex. 1 | Avg. Pore | 150 | 111 | 108 | 208 | 164 |
| | Dia. (μm) | | | | | |
| Ex. 2 | No. of Pores | 7 | 6 | 5 | 1 | |
| | Avg. Pore | 28 | 34 | 36 | 18.8 | |
| | Dia. (μm) | | | | | |
| Comp. | No. of Pores | 100 or | 100 or | 100 or | | |
| Ex. 2 | Avg. Pore | more | more | more | | |
| | Dia. (μm) | 122 | 115 | 73.8 | | |
| Ex. 3 | No. of Pores | 1 | | | | |
| | Avg. Pore | 27 | | | | |
| | Dia. (μm) | | | | | |

### (2) Determination of Number of Pores in Water Contents of Resins

The water content of the resin kneaded materials obtained in Example 2 was adjusted, and the number of pores in the resin kneaded material in each of the water contents (200 ppm, 500 ppm, and 800 ppm) was determined as follows. The results are shown in TABLE 3.

Three 1.5 to 2 g samples having a generally cylindrical column shape of an axial length of 10 mm and a diameter of 10 mm were prepared from the resin kneaded material obtained in Example 2.

The three samples were fed into a high temperature and high humidity tank in which the temperature was set to 60 to 85° C. and the humidity was set to 60 to 85%.

Then, the water contents of the three samples fed into the high temperature and high humidity tank were confirmed with a Karl Fischer measuring device (manufactured by Mitsubishi Chemical Corporation, under the trade name of KF-07) at appropriate intervals, and the samples were taken out from the high temperature and high humidity tank at the time when those water contents reached predetermined amounts (water contents: 200 ppm, 500 ppm, and 800 ppm).

Thus, each of the samples corresponding to the respective water contents (200 ppm, 500 ppm, and 800 ppm) was prepared.

Subsequently, three samples prepared so as to correspond to the water contents were cured under the conditions of 175° C. for 1 hour. Thereafter, each of the three samples thus cured was put into a predetermined vessel and then cooled.

Next, in the same manner as the above-mentioned method, each of the three samples was embedded in the resin for embedding to produce three sample resins, and these sample resins were cut to obtain three test pieces.

Then, in the same manner as the above-mentioned method, the cut surfaces of the obtained test pieces were polished, and in a 2 mm×2 mm area of the kneaded material in each of the polished test pieces, the number of pores and the pore diameter were observed under a digital microscope (manufactured by KEYENCE: VHX-500, observation magnification: 100 times).

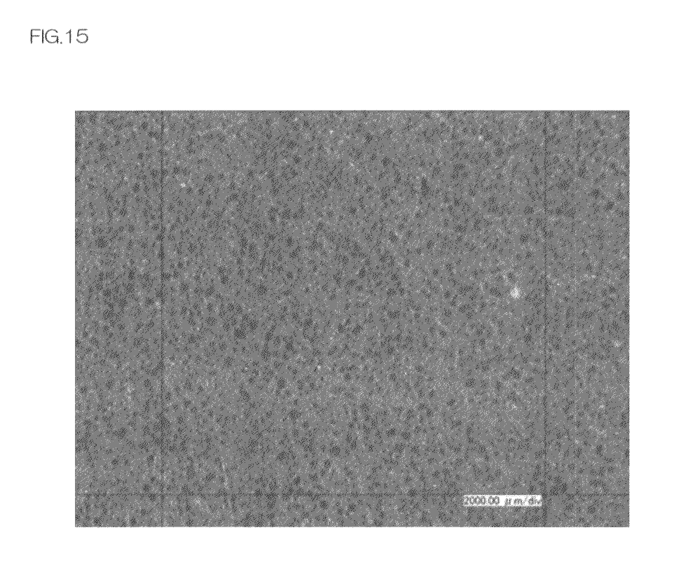

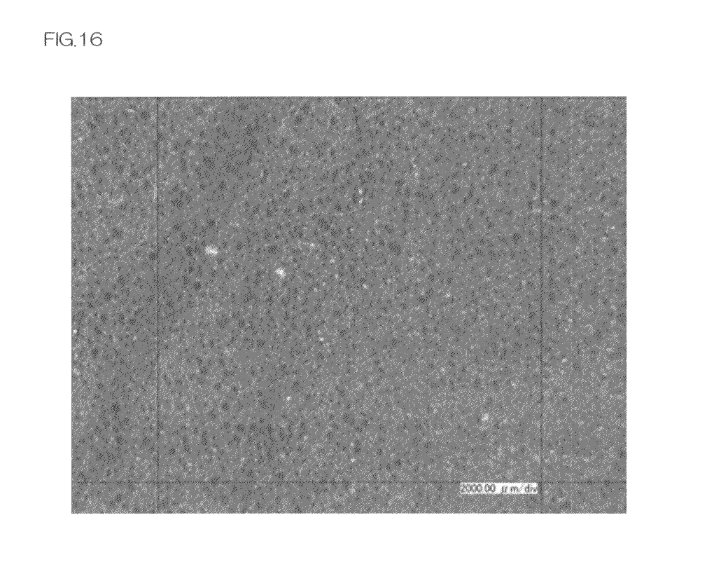

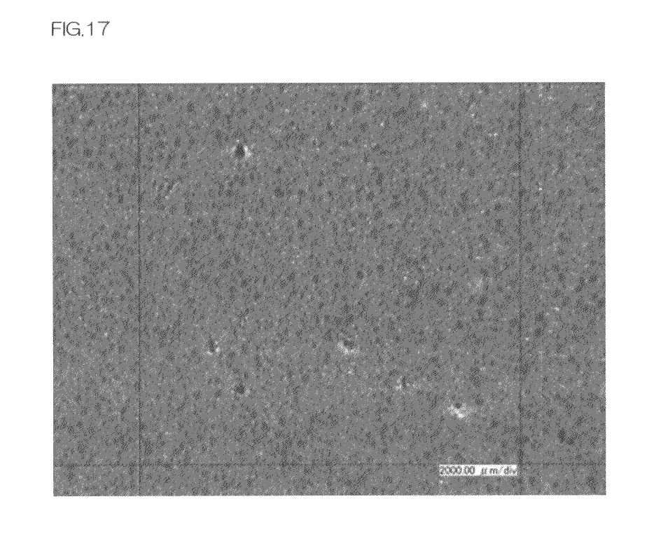

FIG. 15 is a digital microscope photograph of a section of the resin kneaded material (having a water content of 200 ppm) in Example 2. FIG. 16 is a digital microscope photograph of a section of the resin kneaded material (having a water content of 500 ppm) in Example 2; and FIG. 17 is a digital microscope photograph of a section of the resin kneaded material (having a water content of 800 ppm) in Example 2.

TABLE 3

| | | | |
|---|---|---|---|
| Water Content (ppm) | 200 | 500 | 800 |
| No. of Pores | 9 | 30 | 7 |
| Avg. Pore Dia. (μ m) | 14 | 38 | 74 |

While the illustrative embodiments of the present invention are provided in the above description, such is for illustrative purpose only and it is not to be construed as limiting the scope of the present invention. Modifications and variations of the present invention that will be obvious to those skilled in the art are to be covered by the following claims.

What is claimed is:

1. A resin kneaded material having not more than 30 pores having a pore diameter of not less than 20 μm in a surface area of 4.00 mm².

2. The resin kneaded material according to claim 1, having a water content of 0 to 800 ppm.

3. A sheet formed of a resin kneaded material having not more than 30 pores having a pore diameter of not less than 20 μm in a surface area of 4.00 mm².

4. A resin kneaded material obtained by kneading with a kneader,
the kneader comprising
a barrel and a kneading shaft inserted in the barrel,
one end of the barrel being provided with an introducing portion for introducing a to-be-kneaded material into the barrel; and the other end of the barrel being provided with a discharge portion for discharging a kneaded material of the to-be-kneaded material kneaded out of the barrel,
the kneading shaft comprising,
between the introducing portion and the discharge portion in an axial direction of the kneading shaft,
a kneading section for kneading the to-be-kneaded material; and
a low shear section arranged closer to the discharge portion side than the kneading section, having a smooth surface extending without unevenness along the axial direction of the kneading shaft,
being introduced into the barrel from the introducing portion of the kneader and discharging from the discharge portion.
